(19) United States
(12) Patent Application Publication
(10) Pub. No.: US 2014/0003673 A1
(43) Pub. Date: Jan. 2, 2014

(54) HYPERSPECTRAL IMAGERY TRAFFICABILITY TOOL

(71) Applicants: Charles M. Bachmann, Burke, VA (US); Marcos J. Montes, Waldorf, MD (US); Robert A. Fusina, Bryans Road, MD (US)

(72) Inventors: Charles M. Bachmann, Burke, VA (US); Marcos J. Montes, Waldorf, MD (US); Robert A. Fusina, Bryans Road, MD (US)

(73) Assignee: The Government of the United States of America, as represented by the Secretary of the Navy, Washington, DC (US)

(21) Appl. No.: 13/929,026

(22) Filed: Jun. 27, 2013

Related U.S. Application Data
(60) Provisional application No. 61/664,849, filed on Jun. 27, 2012.

(51) Int. Cl. G06K 9/00

(52) U.S. Cl. CPC G06K 9/00476
USPC 382/113

(57) ABSTRACT

A computer implemented method and system for loading a hyperspectral image and one or more spectral libraries associated with the hyperspectral image with an interface module. Spectral matching can then be performed between the hyperspectral image and the one or more spectral libraries to produce a first and second intermediate image product with a matching module. A lookup table can be utilized in the matching module to associate the bearing strength with the one or more spectral libraries for the spectral matching. The first and second intermediate image products can be translated to produce a translated output image product that estimates the corresponding bearing strength of a scene represented in the hyperspectral image with a translation module. The translated output image can represent a trafficability map that can be categorized into different ranges of bearing strength values, wherein each range of bearing strength value is represented by a different color.

### CROSS-REFERENCE TO RELATED APPLICATIONS

This application claims priority to provisional patent application entitled, “Hyperspectral Imagery Trafficability Tool,” filed on Jun. 27, 2012, and assigned U.S. Application No. 61/664,849; the entire contents of which are hereby incorporated by reference.

### FIELD OF THE INVENTION

The invention relates generally to developing trafficability maps. More particularly, the invention relates to a software tool for automating the development of trafficability special maps from hyperspectral imagery.

### BACKGROUND

Trafficability is defined as the ability to move people and/or equipment through a region. Previous methods for estimating trafficability were manually intensive and performed with sparse information obtainable on the ground by engineers at point locations. Typically trafficability products could only be derived from hyperspectral imagery by a skilled analyst using a heuristic approach.

Accordingly, there remains a need in the art for an automated hyperspectral exploitation method instantiated in an end-to-end software tool for developing trafficability products (i.e., special maps of trafficability) from hyperspectral imagery.

### SUMMARY OF THE INVENTION

According to one aspect of the invention, a computer implemented method for loading a hyperspectral image and one or more spectral libraries associated with the hyperspectral image with an interface module. Spectral matching can then be performed between the hyperspectral image and the one or more spectral libraries to produce a first and second intermediate image product with a matching module. A lookup table can be utilized in the matching module to associate the bearing strength with the one or more spectral libraries for the spectral matching. The first and second intermediate image products can be translated to produce a translated output image product that estimates the corresponding bearing strength of a scene represented in the hyperspectral image with a translation module. The translated output image can represent a trafficability map that can be categorized into different ranges of bearing strength values, wherein each range of bearing strength value is represented by a different color.

According to another aspect of the invention, a system includes an interface module configured to load a hyperspectral image and one or more spectral libraries associated with the hyperspectral image. A matching module can be configured to perform spectral matching between the hyperspectral image and the one or more spectral libraries to produce a first and second intermediate image product. The matching module can include a lookup table that associates the bearing strength with the one or more spectral libraries utilized for the spectral matching. A translation module can be configured to translate the first and second intermediate image product to produce a translated output image product that estimates the corresponding bearing strength of a surface represented in the hyperspectral image. The translated output image product can be a trafficability map that can be categorized into different ranges of bearing strength values, wherein each range of bearing strength value is represented by a different color.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a flow chart of a hyperspectral imagery trafficability software tool, in accordance with an exemplary embodiment of the invention.

FIG. 2 is an example hyperspectral image in accordance with an exemplary embodiment of the invention.

FIG. 3A is an example of a first intermediate image product in accordance with an exemplary embodiment of the invention.

FIG. 3B is an example of a second intermediate image product in accordance with an exemplary embodiment of the invention.

FIG. 4 is an example of a translated output image product in accordance with an exemplary embodiment of the invention.

FIG. 5 is an example of a categorized translated output image product in accordance with an exemplary embodiment of the invention.

### DETAILED DESCRIPTION OF EXEMPLARY EMBODIMENTS

Referring now to the drawings, in which like numerals represent like elements, aspects of the exemplary embodiments will be described in connection with the drawing set.

In general, a software tool, known as a Hyperspectral Imagery Trafficability Tool (HITT), is described herein. The software tool can utilize hyperspectral imaging and spectral-geotechnical libraries and models to exploit this imagery and provide a robust, wide-area output image, which can be a map of estimated soil, sand, or sediment bearing strength. One of ordinary skill in the art will understand that spectral and geotechnical libraries utilized by the software tool may be available from a variety of different sources. For example, the spectral and geotechnical libraries can be developed through on-site data collection, or remote sensing and calibration and validation (cal/val) campaigns. The libraries are important components in ultimately estimating dynamic deflection modulus, i.e. bearing strength in units of pressure, from hyperspectral remote sensing.

In an exemplary embodiment of the invention, the software tool can be an add-on component to a larger software package, such as the ENVI/IDL software package. One of ordinary skill in the art understands that the ENVI/IDL software package is typically known as one of the premier geospatial software packages that processes and analyzes imagery. For example, a series of routines, or modules, can be run within the larger software package environment. The routines can have relatively simple graphical user interface (GUI) components, which can query the user to provide the necessary inputs and ultimately render and save the resulting products (e.g., trafficability maps) automatically. Collectively this set of routines can comprise the HITT tool. Other types of software configurations (i.e., not as an add-on component to a larger software package), such as a stand-alone software package, can also be utilized.

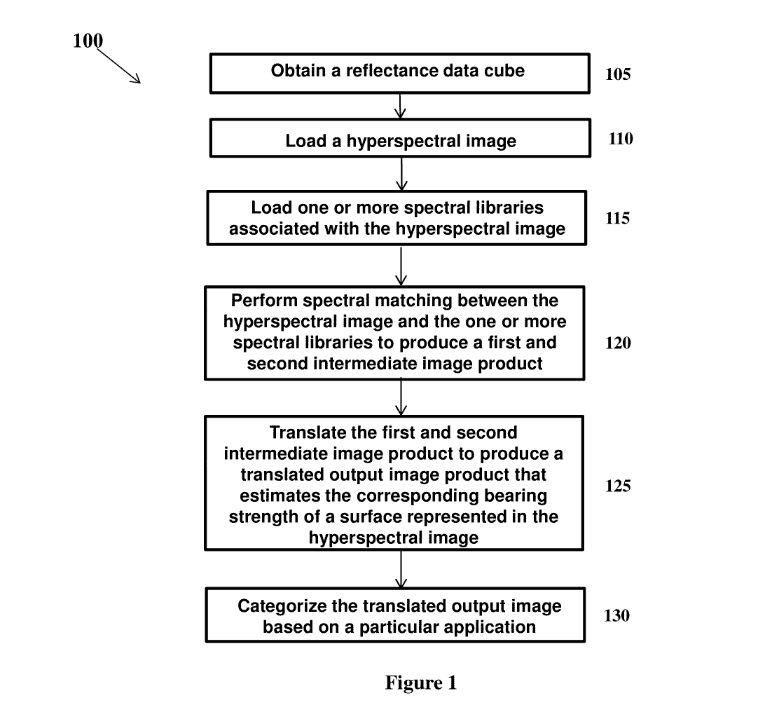

FIG. 1 is a flow chart 100 of a hyperspectral imagery trafficability software tool, in accordance with an exemplary embodiment of the invention. In Step 105, a reflectance data cube can be obtained. In an exemplary embodiment of the invention, the end-user of the software tool can have a hyperspectral calibrated radiance file. The hyperspectral calibrated radiance file can allow the end-user to obtain a reflectance data cube, which means that the data consists of the reflectance as a function of wavelength for each (x,y) location in the image. The reflectance data cube is essential to compare the imagery reflectance data with the spectral-geotechnical libraries, which are also in the dimensionless units of reflectance.

However, if the end-user of the software tool does not have a hyperspectral calibrated radiance file, then the end-user must atmospherically correct the data to obtain the reflectance data cube, as the input hyperspectral imagery is typically in the form of a reflectance data cube. In an exemplary embodiment of the invention, an available software tool, such as Tafkaa, which is an atmospheric correction software, can allow end-users to produce the atmospherically corrected reflectance data cube. Alternatively, the end-user can elect to perform atmospheric data correction using another available atmospheric correction software tools, such as FLAASH or QUAC. Other commercially available alternatives can also be utilized.

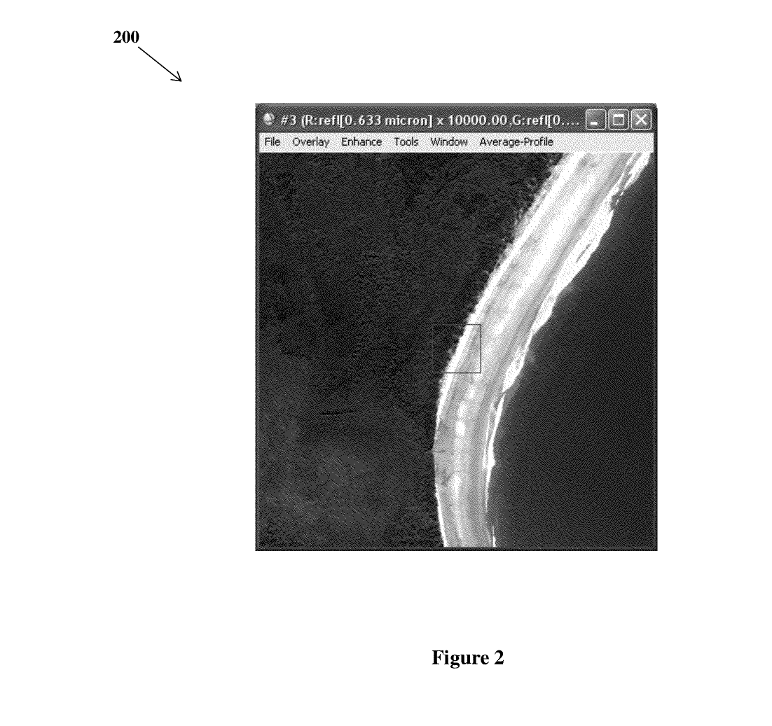

In Step 110, after a reflectance cube has been obtained, a hyperspectral image file can be loaded for processing. The hyperspectral image file can represent a hyperspectral image scene, such as a coastline. For example, in an interface module of the software tool, an end-user can navigate to a menu to select and open a hyperspectral image stored in a directory. FIG. 2 is an example hyperspectral image 200 in accordance with an exemplary embodiment of the invention.

Once the user has selected the hyperspectral image to be processed, the user can be prompted to determine whether or not to apply a threshold to the matching algorithm results. As will be discussed in more detail in Step 125, the reflectance spectrum at each (x,y) point in a hyperspectral image can be compared against all the spectra in a look up table and can be given a single number that tells how “close” it is to each of the LUT spectra. The threshold can determine how “close” that value has to be to be considered a match. Therefore, if none of the values are smaller than the threshold, the pixel can be labeled as “no match.” By way of example, there can be three spectra in the lookup table and a particular pixel can have match values of 12, 17 and 19. Of the threshold was set to 10 then that pixel would be labeled as “no match” since none of the match values is smaller than the threshold. However, if the threshold were set at 15, then the pixel would be labeled as matching the spectrum with which it has the match value of 12.

To apply a threshold to the matching algorithm results, a radio-box style interface can appear in the software giving the user the option to either accept or reject the idea of using a threshold with the matching scores between hyperspectral imagery pixels and the closest matching spectral library element. If the user selects the option to use a threshold, a second window can appear prompting the user to enter the threshold value. A default threshold value can be provided; however, the user may wish to experiment with this threshold value in order to determine which regions of the image can be excluded as the threshold is changed.

The threshold value can correspond to a threshold on the distance in spectral space between the closest matched spectrum and the spectrum of a given image pixel, where the comparison between these two spectra is the distance in spectral space. One of ordinary skill in the art will understand that other matching algorithms could potentially be applied here, such as the “spectral angle mapper” available in the ENVI software package.

In Step 115, one or more spectral-geotechnical libraries, associated with the hyperspectral image, can be loaded in the software tool. For example, in an interface module of the software tool, an end-user can load one or more of the individual spectral libraries, or the user can load a master library and select either all or the relevant subset of libraries to be used. Specifically, the user can navigate to a menu in the software tool to open one or more spectral library files stored in a directory.

In an exemplary embodiment of the invention, after selecting the one or more spectral libraries, the user can be prompted to enter the first of two output product filenames. The first filename requested can be the filename of the “Minimum Distance to Closest Spectrum” image product. This first intermediate image product can be a diagnostic result that can show the user an image of the closest distance found to an element of the spectral library for each pixel in the original input hyperspectral image scene that the user selected in the previous step.

Once the user has chosen the appropriate filename for the first intermediate image product, the user can be asked to name the filename of the “Index of Closest Matching Spectrum” image product. This second intermediate image product can contain the index in the spectral library of the closest matching spectrum to each pixel in the input hyperspectral image scene. Note that in this second intermediate image product, an index of 0 can correspond to the case where no match could be found within the prescribed set by the user, if the user opted to use a threshold as described in Step 110. Otherwise, the whole scene can be mapped, but the number of the spectral library elements will still start from 1, as the number 0 can be reserved for the “no match” category.

In Step 120, spectral matching between the hyperspectral image and one or more spectral libraries can be performed with a matching module. Initially, in the spectral matching processing step, the matching module can perform some preliminary processing steps to the spectral library before the matching is undertaken. For example, the program can scan the spectra to make sure that there is no bad data, such as “Inf” or “NaN,” in any of the fields. These types of bad data can sometimes be observed in spectral library files where the processing of the reflectance data has become numerically unstable, usually around the large atmospheric absorption bands that often produce very small radiance values that become numerically unstable in the ratios that are taken to obtain reflectance. Typically, these are omitted as “bad bands,” but the matching module can make sure that there are no residual problems. If the matching module does find “Inf” or “NaN” entries in the spectral vectors of the library, it can zero these values out (i.e., replace those values with zeros), and can copy the contents of the spectral library to a new spectral library with a different file name that can be utilized in place of the spectral library with the bad data.

After any non-numeric data problems are removed from the data, the spectral library can then be resampled to the band centers and Full-Width-at-Half-Maximum (FWHM) of the hyperspectral image scene to be processed. The resulting spectral library can be loaded into the available bands list in the software package, and the spectral library filename can again be changed to create another new file. Finally, the two new spectral library files can be saved automatically in the same directory as the original spectral library file.

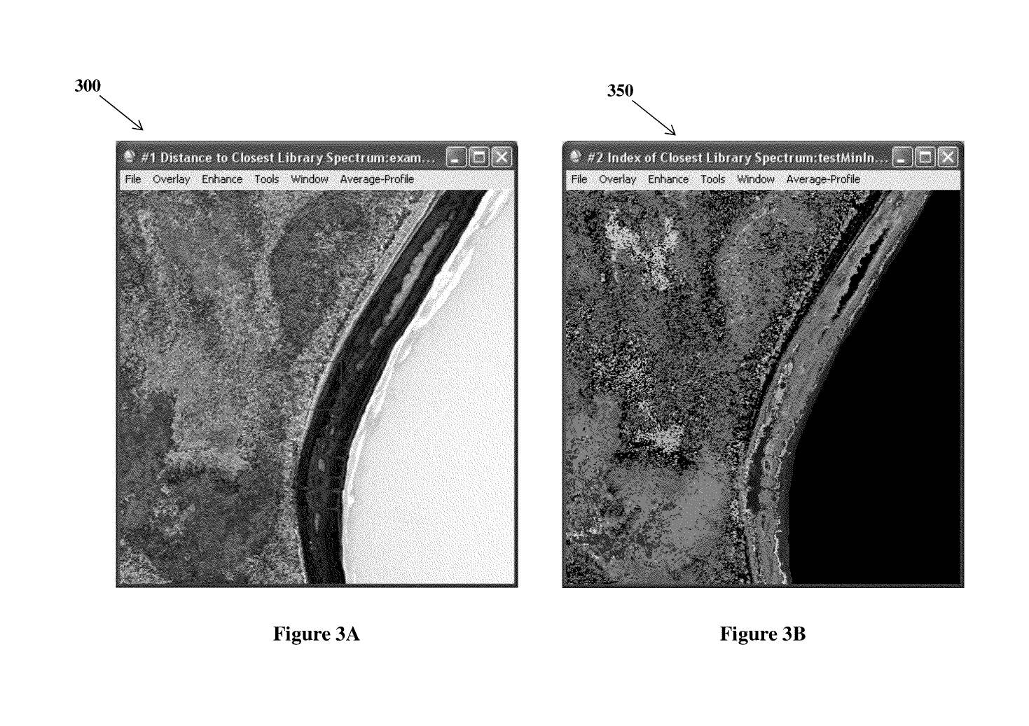

After the initial processing steps in the spectral matching phase, the matching module can process the hyperspectral image scene. As a result, the two intermediate image products named by the end user in Step 115 can be produced and automatically saved in a user-specified location. These two intermediate image products can represent a set of intermediate products in the overall workflow leading to the final bearing strength output image product. Specifically, the first of these two intermediate image products can be a map of the minimum distance to the closest element found in the spectral library at each pixel in the input hyperspectral image. FIG. 3A is an example of a first intermediate image product 300 in accordance with an exemplary embodiment of the invention. This product can initially appear in a default color map, which can render this product as a grey-level image; however, as with any image, this product can easily be re-rendered in one of many available color maps found in the software package, such as in FIG. 3B, or the user can define his own color map.

The second intermediate product image that appears at the conclusion of processing by the matching module can be a map of the index of the closest matching spectrum found in the spectral library selected by the user using an interface component. FIG. 3B is an example of a second intermediate image product 350 in accordance with an exemplary embodiment of the invention.

For example, in FIG. 2, the hyperspectral image reflects a coastline with water, sand, and other soil signatures represented. In this example, the spectral matching processing will attempt to match to spectra such as sand and other soil signatures on the surface of the hyperspectral image in the spectral library. However, the ocean water in the image can appear as category “0” or unlabeled data resulting from a poor spectral matching score, which did not pass the rejection threshold set by the end user in a previous step. The user can understand the details of this result by selecting a “Cursor Location/Value” option from the “Tools” menu of the image display of the distance-to-closest-element-of-the-spectral-library image product, and then placing the cursor over various parts of the scene. This option can present a contrast of the residual error in the best spectral match to the spectral library for a pixel on the beach, which can have a very low residual error (e.g., 0.05) with that of one of the water pixels, which can have a high residual error (e.g., 1.3).

The “Cursor/Location Value Tool” can also provide additional data when the cursor is placed over the second output product image of the closest matching spectral index. Specifically, a data box can appear that shows a region of good matching for a sand pixel, along with a poor matching over the water region which did not pass the user-entered matching threshold, and was associated, therefore, with the unlabeled category, with index 0. In this instance, the data box in the software can read “Unclassified” for the category name when assigned to the rejected or unlabeled category and display the index 0 as the numerical value.

The second output product image (i.e., the closest matching spectral index output product) can have an associated header file that can define the file type, and the header can be populated by the matching module with a default set of class or category names, which can be just the names of the spectral library elements. These names, along with the spectrum index in the library, can appear when a particular pixel in this output product is highlighted.

Finally, when the matching module has finished execution, the hyperspectral image scene that was specified by the user as input image file in Step 110 can also be rendered in the usual way within the software tool.

In Step 125, a translation module can translate the intermediate first and second output products produced by the spectral matching module in Step 120 to a translated output image product, or trafficability map, which estimates the corresponding bearing strength of the sand, soil, or sediment. In an exemplary embodiment of the invention, the translation module, or routine, can convert the mapped best spectral matches using a lookup table approach, which can associate dynamic deflection modulus with the spectral library used in matching. The correlations that exist between spectral reflectance and the geotechnical properties measured at the same location can be the basis of this translation. For example, some of the fundamental properties that can determine bearing strength include, but are not limited to, moisture, grain size, and composition. All of these properties can influence the observed spectra in hyperspectral remote sensing.

In general, hyperspectral remote sensing obtains information about the surface properties of the earth, but typically cannot glean information about what is below the surface layer, except in a statistical manner. However, there are likely to be natural relationships based on, for example, coast type and position relative to the shoreline that do exist, making such inferences possible. Surface moisture level and composition can be relatively easy to retrieve from hyperspectral remote sensing. Grain size can be more difficult, but it is still feasible, although explicit models that currently exist for grain size do not typically cover all of the ranges of conditions that one might encounter. Therefore, using a look-up table can take the place of an explicit model in order to be able to address a broader range of conditions that might be encountered.

In an alternative exemplary embodiment, the lookup table can be replaced by a multi-sensor remote sensing component. The multi-sensor remote sensing component can be used as a means of overcoming the limitations of hyperspectral remote sensing, which typically only records information from the surface. For example, the multi-sensor remote sensing component can include individual sensors, or models, which provide for the retrieval of various quantities related to one or more geophysical parameters. For example, multi-sensor remote sensing component can provide quantities related to bearing strength such as soil moisture, grain size, and composition (i.e., intermediate physical variables). Some examples of complementary remote sensing components include the use of synthetic aperture radar (SAR) to estimate volumetric soil moisture, or thermal imagery acquired at different times to learn more about the thermal conductivity of layers beneath the surface. One of ordinary skill in the art will understand other types of remote sensing components that could be utilized.

As described in Step 125, a lookup table approach can be utilized. The lookup table approach can be a direct relationship table between measured bearing strength and spectral reflectance. However, one of ordinary skill in the art would understand that the lookup table approach could also be applied to the retrieval of the intermediate physical variables as well.

In an exemplary method of building a lookup table, ground measurements of spectral reflectance can be measured with an ASD spectrometer, and those measurements can be complemented by bearing strength measurements with a lightweight deflectometer at the same location. Then, the look-up tables can provide a one-to-one association between the measured spectral reflectance of the surface and the bearing strength (i.e., dynamic deflection modulus) recorded by the lightweight deflectometer. Other geotechnical measurements, or geotechnical parameters, such as shear strength, soil moisture, and grain size distributions, can also be recorded at the same location.

In an exemplary embodiment of the invention, the spectral geotechnical look-up tables can be simple ASCII files relating three quantities: (1) a name identifying the spectrum; (2) the associated spectral index (this is the integer class label assigned to each spectrum in the lookup table that can be assigned during classification either by the matching module or by some equivalent matching already performed in the larger software package); and finally, (3) the associated geotechnical parameter associated with the spectrum. As described herein, the geotechnical parameter discussed with regards to this invention is the bearing strength; however, one of ordinary skill in the art will understand that this format could well be applied to other geotechnical parameters.

In an exemplary embodiment of the invention, a lookup table module can be provided as an interface for constructing the spectral geotechnical look-up tables. The advantage of using the lookup table module is that it can provide a direct interface into the spectral libraries already used within the software tool for the spectral matching. Furthermore, the software tool can load associated spectral names and indices directly from the header information of the spectral libraries used during the matching procedure. The interface associated with the lookup table module can also allow the user to sub-select items from the spectral table, or from previously constructed spectral-geotechnical tables. It can also permit rapid construction from spectral libraries and associated tables of geotechnical parameters that might be in separate files from field measurements, or construction of a new table can begin by selecting a pre-existing table to start with. In an alternatively embodiment, the user can elect to construct the table offline in a standard editor or in a spreadsheet program, such as Microsoft Excel, that can export the result into an ASCII format.

If a user decides to build a new lookup table, the lookup table module can provide the user with a series of options to construct a table from scratch. For example, an interface can appear prompting the user to enter the name of a spectral library to be used in constructing the new look-up table. Next, an option can appear asking the user to specify whether there is a file with a list of geotechnical values already in one-to-one correspondence with the spectral file selected. If the user selects ‘No’, the lookup table module can assume that the geotechnical values are to be entered through the interface manually. However, if the user selects ‘Yes’ in response to that inquiry, another interface can appear asking the user to select the name of the file holding the geotechnical list values.

After the initial options are completed, the lookup table module can merge the geotechnical values from the geotechnical list file that are in one-to-one correspondence with the spectral library samples (e.g., from field measurements) and their spectral names parsed from the header of the spectral library file. Additionally, the lookup table module can add a spectral index consistent with the conventions described previously for the matching module, and standard matching routines. The layout of the new merged result can be a table with three columns for the spectral name, spectral index, and corresponding geotechnical value.

The lookup table module can also add an entry for unlabeled or unclassified data in the scene. This can correspond to unlabeled parts of the scene not classified by the spectral matching routine that have spectral index 0 in the classification result, and have spectral name “Unclassified.” An assumption can be made that since these regions have no data, that the appropriate geotechnical value to associate with this unlabeled category is a value of 0.0; however, the user can edit this value later if a different convention is to be followed.

With the created lookup table, the user can select entries to include in the look-up table through an interface, and the user can toggle on or off individual look-up table entries, add ranges, select all elements, or clear selections. Other functions in the interface can also be implemented. When finished, the user can enter a filename for the lookup table and store it, though the user can still have the opportunity to make any final revisions, such as editing specific entries, deleting any unwanted entries, pasting in entries from another file, or manually typing in new entries.

After the lookup table is created and stored, the next step can be to begin the translation process from the intermediate output products of the spectral matching procedure. This step can be accomplished with a translation module that can be loaded by the user. When the translation module is set to run, the user can be prompted to select which previously labeled scene the user wants to be translated by the spectral-geotechnical look-up table. After the spectral index image has been selected for translation, the user can then be prompted to select which lookup table must be loaded. Finally, the user can be prompted to enter a filename for the translated output image. After the filename is entered, the processing can begin. When the translation process is completed, the translated output image can be automatically rendered.

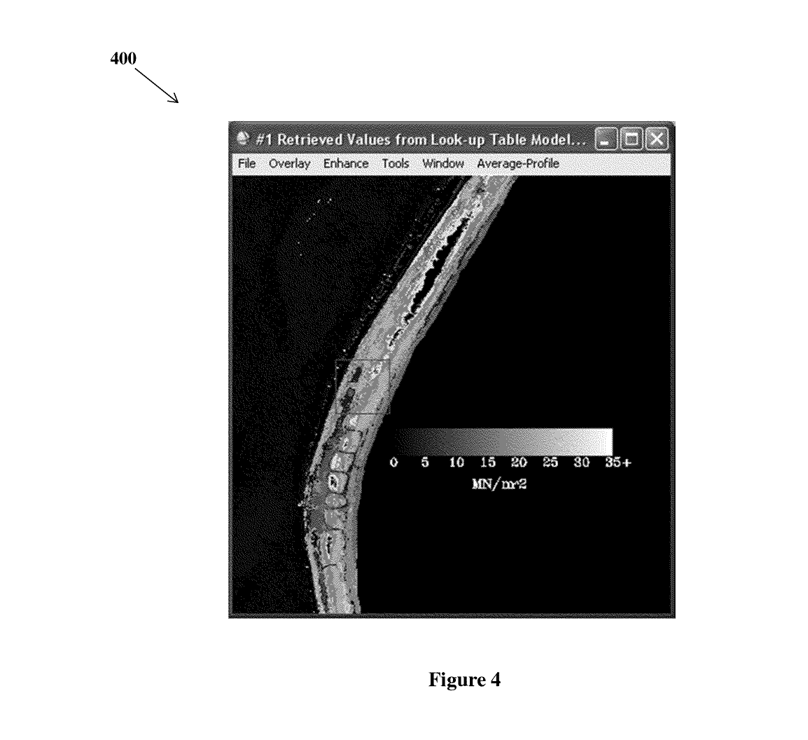

The translated output image can show the retrieved map of estimated bearing strength. FIG. 4 is an example of a translated output image product 400 in accordance with an exemplary embodiment of the invention. The software package can have tools that can allow the translated output image to be displayed in multi-color maps. The image can also show a data legend, which can describe how the displayed color relates to estimated bearing strength. The use of multi-color maps reflecting different colors for different bearing strengths can allow a user to quickly assess the potential trafficability of the ground surface of the scene. The user can also have the ability to make edits to the display features of the legend, such as minimum and maximum for the given image stretch, character fonts, etc. Additionally, the user can add text to the image, such as the units (e.g., MN/m2) for the bearing strength.

The steps to produce the translated output image can be applied to any measured geophysical parameter that has been associated with a particular spectrum. The steps herein describe the process of the software tool when dealing with the geophysical parameter of the dynamic deflection modulus. However, the same software modules could be run equally well, employing spectral libraries linked through a lookup table to other geo-technical parameters.

In Step 130, the translated output image can be categorized based on a particular application. More specifically, a user can re-bin the real-valued bearing strength output (dynamic deflection modulus in units of pressure) into categories (e.g., poor, fair, good, and/or excellent), or some other set of ratings based on how these bearing strength estimates are to be interpreted in the context of the end-user's application.

In one example of categorizing the output image, a bin module can be used to section the bearing strength data into distinct bands, or ranges of dynamic deflection modulus values in MN/m². After a user makes a selection that they would like to categorize the data in the output image, an interface can display proposed “bin” ranges to categorize the data. A user can select the proposed bins, or they can edit them by changing the number of bins, the bin ranges individually, or alternatively, the user can elect to re-load a previously constructed set of bins saved in a previous session.

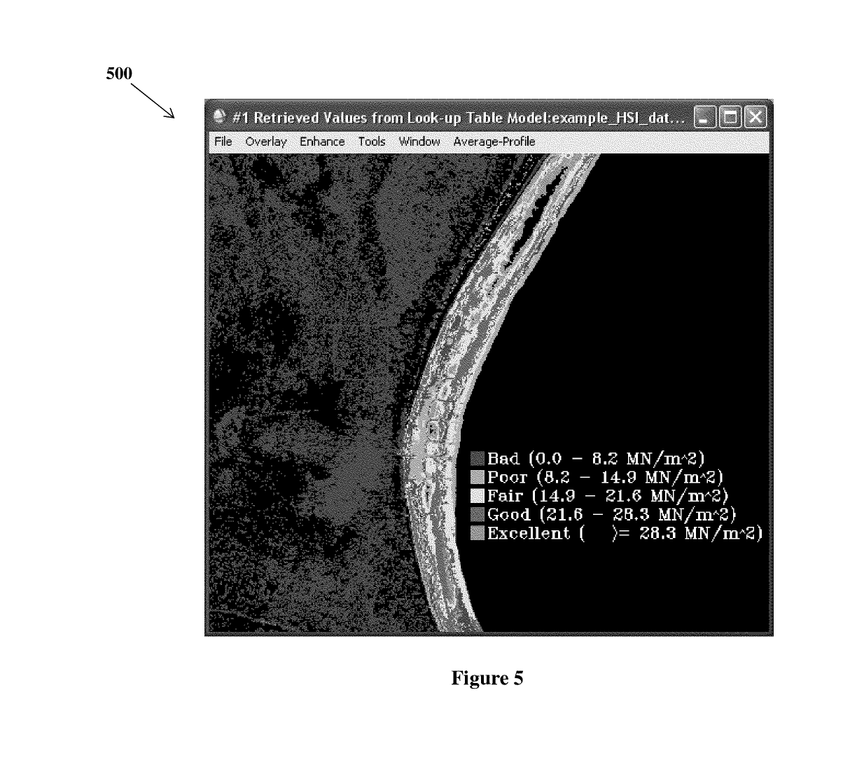

By way of example, the output image can be divided into ranges based on the retrieved bearing strength estimate, which is in units of MN/m2. For example, five bins can be created and labeled “Bad”, “Poor”, “Fair”, “Good”, and “Excellent.” In this example, the ranges for the five categories are depicted in Table 1 below. Obviously, the specific manner in which the data is to be binned will depend on the user's application. FIG. 5 is an example of a categorized translated output image product 500 in accordance with an exemplary embodiment of the invention.

TABLE 1

| Bearing Strength | LWD Measured |
|---|---|
| Conditions Example | Dynamic Deflection |
| Categories | Modulus in MN/m² |
| Excellent | 28.3 or greater |
| Good | 21.6-28.3 |
| Fair | 14.9-21.6 |
| Poor | 8.2-14.9 |
| Bad | 0-8.2 |

In an exemplary embodiment of the invention, after the binning of the data has been selected, the user can apply a key to the resulting output image by using an annotation tool in the software package. The annotation tool can allow the user to edit the image key items, such as changing the text and color code associated with each entry. For example, for the data in Table 1, which corresponds to trafficability map in FIG. 5, different colors can be associated with the bearing strength conditions example categories. Specifically, as represented in the color map of FIG. 5, the excellent category can be represented by a light green; the good category can be represented by a dark green; the fair category can be represented by yellow; the poor category can be represented by orange; and the bad category can be represented by red.

Portions of the invention can comprise a computer program that embodies the functions described herein and illustrated in the appended flow charts. Furthermore, the modules described herein can be implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an exemplary embodiment based on the flow charts and associated description in the application text. Therefore, disclosure of a particular set of program code instructions is not considered necessary for an adequate understanding of how to make and use the invention. The inventive functionality of the claimed computer is explained herein in more detail read in conjunction with the figures illustrating the program flow.

It should be understood that the foregoing relates only to illustrative embodiments of the present invention, and that numerous changes may be made therein without departing from the scope and spirit of the invention as defined by the following claims.

1. A computer implemented method, comprising the steps of:
loading a hyperspectral image and one or more spectral libraries associated with the hyperspectral image with an interface module;
performing spectral matching between the hyperspectral image and the one or more spectral libraries to produce a first and second intermediate image product with a matching module;
translating the first and second intermediate image product to produce a translated output image product that estimates the corresponding bearing strength of a scene represented in the hyperspectral image with a translation module.

2. The method of claim 1, further comprising the step of obtaining a reflectance data cube prior to loading the hyperspectral image and the one or more spectral libraries.

3. The method of claim 1, wherein reflectance data can be obtained from the hyperspectral image.

4. The method of claim 1, wherein the first intermediate image product represents a minimum distance to closest spectrum image product.

5. The method of claim 1, wherein the second intermediate image product represents an index of closest matching spectrum image product.

6. The method of claim 1, wherein the translated output image product represents a trafficability map.

7. The method of claim 6, wherein the trafficability map is represented as a map comprising a plurality of colors.

8. The method of claim 1, wherein the step of translating the first and second intermediate image product to produce a translated output image product comprises the step of utilizing a lookup table to associate the bearing strength with the one or more spectral libraries utilized for the spectral matching.

9. The method of claim 8, wherein the lookup table can be constructed by recording ground measurements of spectral reflectance and complementing those measurements with bearing strength measurements at the same location.

10. The method of claim 1 wherein the step of translating the first and second intermediate image product to produce a translated output image product comprises the step of utilizing a multi-sensor remote sensing component that provides quantities related to one or more geophysical parameters.

11. The method of claim 1, further comprising the step of categorizing the translated output image based on a particular application.

12. The method of claim 11, wherein the step of categorizing the translated output image based on a particular application comprises the step of categorizing the translated output image into different ranges of bearing strength values, wherein each range of bearing strength value is represented by a different color.

13. The method of claim 1, wherein the bearing strength of the scene corresponds to the bearing strength of a ground surface.

14. A system, comprising:
an interface module configured to load a hyperspectral image and one or more spectral libraries associated with the hyperspectral image;
a matching module configured to perform spectral matching between the hyperspectral image and the one or more spectral libraries to produce a first and second intermediate image product;
a translation module configured to translate the first and second intermediate image product to produce a translated output image product that estimates the corresponding bearing strength of a surface represented in the hyperspectral image.

15. The system of claim 14, wherein the matching module further comprises a lookup table that associates the bearing strength with the one or more spectral libraries utilized for the spectral matching.

16. The system of claim 14, wherein the matching module further comprises a multi-sensor remote sensing component configured to provide quantities related to one or more geophysical parameters.

17. The system of claim 14, wherein the translated output image product is a trafficability map.

18. The system of claim 17, wherein the trafficability map is represented as a map comprising a plurality of colors.

19. The system of claim 14, wherein the translation module is further configured to categorize the translated output image into different ranges of bearing strength values, wherein each range of bearing strength value is represented by a different color.
